(19) United States
(12) Patent Application Publication
(10) Pub. No.: US 2017/0372645 A1
(43) Pub. Date: Dec. 28, 2017

(54) Spinning Signage

(71) Applicant: Christopher Cross, Littleton, CO (US)

(72) Inventor: Christopher Cross, Littleton, CO (US)

(21) Appl. No.: 15/615,824

(22) Filed: Jun. 6, 2017

Related U.S. Application Data
(60) Provisional application No. 62/346,436, filed on Jun. 6, 2016.

(51) Int. Cl. G09F 7/22; A63H 33/40; G09F 7/20; G09F 7/18

(52) U.S. Cl. CPC G09F 7/22; G09F 2007/1804; A63H 33/40; G09F 7/20

(57) ABSTRACT

Provided herein are novel signage devices. The signage devices comprise printed elements comprising, or in connection with a pinwheel assembly, such that the printed elements will rotate in the wind and catch attention by their movement. The signage devices of the invention are especially amenable to depicting and advertising round objects, such as a pizza.

### CROSS-RELATED APPLICATIONS

This application claims the benefit of priority to U.S. Provisional Application Ser. No. 62/346,436, entitled “Spinning Signage,” filed Jun. 6, 2016, the contents of which are hereby incorporated by reference.

### BACKGROUND OF THE INVENTION

In a world saturated with advertising, it is difficult for signage to gain the attention of the public, as people have learned to tune out ubiquitous advertising materials. The human eye and mind are attuned to motion and moving signage is typically more eye-catching than static signage. The prior art contains various signage systems that move in order to catch the attention of persons. For example, inflatable fabric bodies that sway and undulate are common. Another form of movement based signage is the human powered sign spinner, being a person twirling a printed sign, typically at the road side.

The prior art systems are generally expensive, requiring expensive motors, blowers, and other equipment. Likewise, human powered advertising incurs labor costs. Accordingly, there is a continuing need in the art for signage systems that catch attention and which are low-cost to produce, deploy, and maintain.

### SUMMARY OF THE INVENTION

Disclosed herein is a novel kinetic, wind-powered signage system that fulfills the needs of the prior art, providing an effective means of capturing attention that is low-cost, readily deployed, and easily maintained. The signs of the invention advantageously provide an effective means of advertising. The signs of the invention are environmentally friendly in that no power is required to display them.

### BRIEF DESCRIPTION OF THE DRAWINGS

FIG. 1 depicts an exemplary pinwheel assembly.

FIG. 2 depicts an exemplary pinwheel assembly.

FIGS. 3A and 3B. FIG. 3A depicts a pinwheel sign comprising a printed sheet affixed to the pinwheel assembly, frontal view. FIG. 3B depicts the same pinwheel sign in a side view.

FIG. 4 depicts a printed pinwheel assembly.

FIG. 5 depicts an exemplary mounting system comprising an arm and a pole.

FIG. 6 depicts a novel mounting device for affixing pinwheel signs to a pole.

FIG. 7 depicts a signage system comprising two pizza signs mounted to a pole.

### DETAILED DESCRIPTION OF THE INVENTION

The kinetic, wind-powered signage system of the present invention, comprises what will be referred to as “pinwheel signs.” The pinwheel sign comprise several elements, as described next.

Pinwheel Assembly: The pinwheel sign will comprise a pinwheel assembly, being a structure which rotates under the power of air currents. The pinwheel assembly will comprise a plurality of blades, the blades of the pinwheel being individual sails or air catching elements, configured to catch a flowing air current, such that the flowing air will cause the blade assembly to rotate around a central axle. Blades are typically constructed from planar materials such as paper or sheets of plastic, acetate, metal foil, or other materials. The use of thin, sheet-like materials such as plastic, acetate, paper, foil, among other materials means the blade can have a low weight-to-surface-area ratio, making the blade assembly easy to turn with low volume air currents.

Any number of blades more than two may be used. In exemplary pinwheel designs, four, five, six, or eight blades are used. The blades may be pointed, rounded, substantially planar, or may comprise complex geometries. The blades may be curved, curled, folded, or otherwise bent so as to create a lateral surface area that will catch air currents.

The pinwheel assembly will be configured such that it may rotate around an axle. In one embodiment, the blades of the pinwheel assembly are affixed radially to a central housing comprising a ring, cylindrical body, other body having a hole through its central axis that allows rotation around an axle. In an alternative embodiment, the converging blades form the central housing, in the form of a central ring through which the axle passes, and no additional structure is present.

The pinwheel assembly may further comprise an axle, around which the assembly rotates. The outward end of the axle may be capped with a structure such as a cap, comprising a flange or plate, which structure keeps the pinwheel sign from sliding off front end of the axle. In some embodiments, the cap is removable (e.g. can be screwed onto the end of the axle), such that pinwheel sign can be removed from the axle. In one embodiment, the cap is a wingnut. In one embodiment, the cap is a cotter pin.

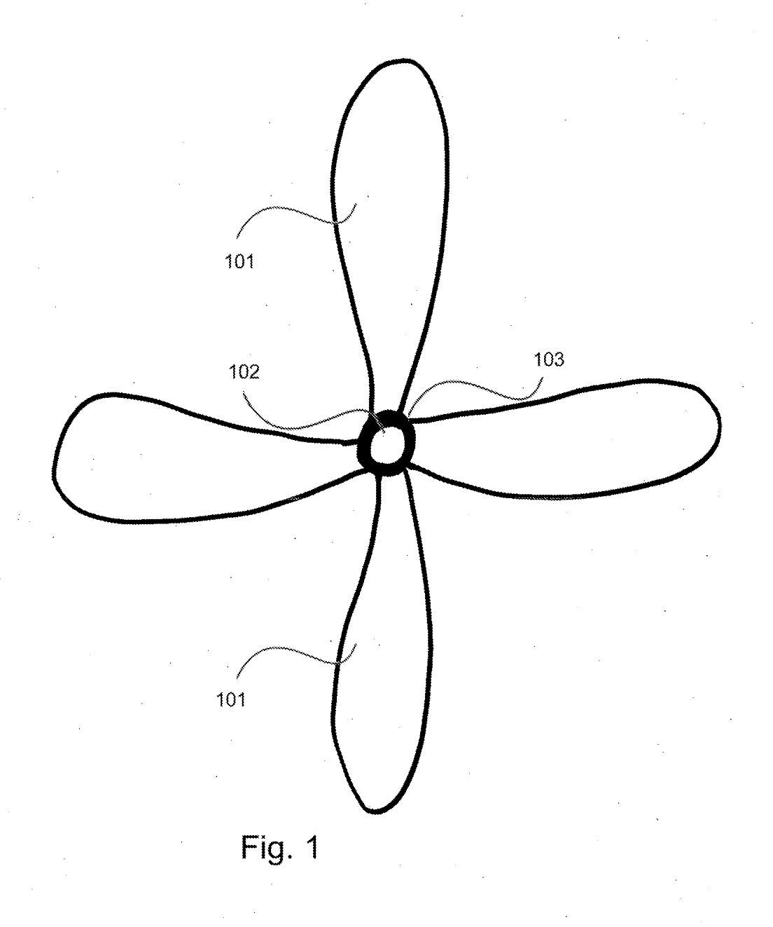

An exemplary pinwheel assembly is depicted in FIG. 1. The pinwheel of FIG. 1 comprises four blades (101) attached radially around a central housing (103), comprising a tubular or cylindrical component with a hole (102) in its central axis through which an axle may be placed. The blades may be curved or angled to catch air.

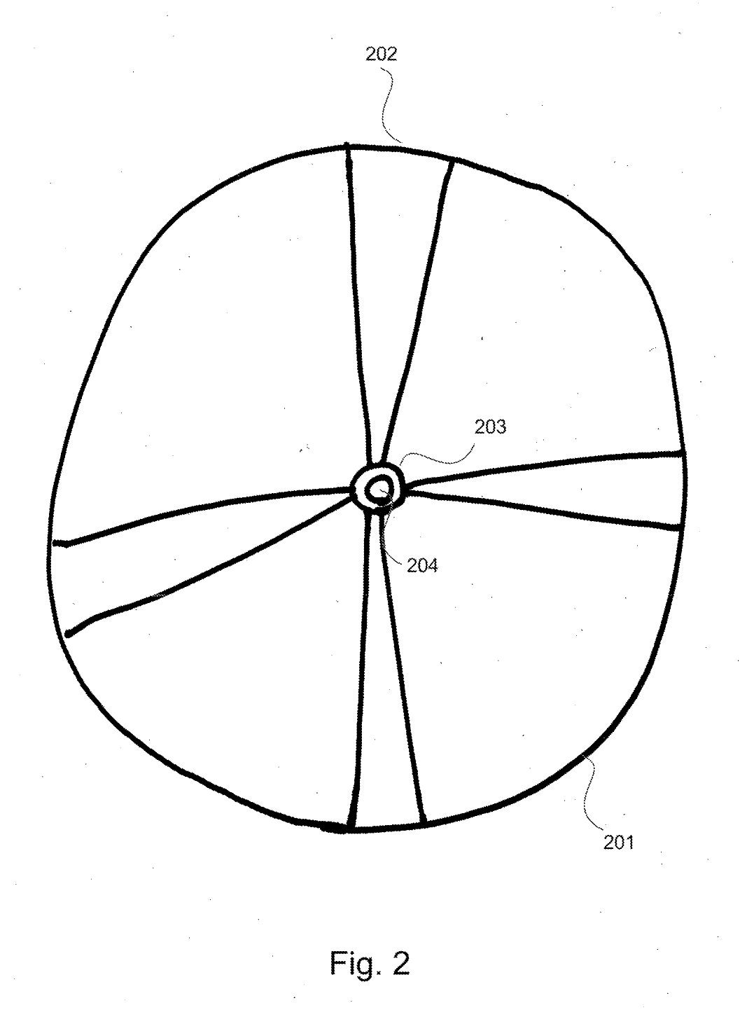

A second exemplary pinwheel assembly is depicted in FIG. 2. The pinwheel of FIG. 2 comprises a central housing (203) having a hole in its central axis (204). Four blades (202) are arranged radially around the central housing, being attached at their terminal ends to a hoop or ring (201). The blades may be angled to catch air.

Printed Surface: The pinwheel signs of the invention further comprises one or more printed surfaces, configured as described in the exemplary embodiments below.

On the printed surface, any desired advertising material or graphics can be printed. The printed surface(s) will typically be the outward facing surface that is visible to persons viewing the sign head on. In one embodiment, the printed surface(s) is circular. In one embodiment, the printed surface(s) depicts a round object. The round object depicted may be, for example, a pizza, doughnut, bagel, pie, cake, tire, wheel, record, cookie, sushi roll, half melon, cheese wheel, or other circular or substantially circular object.

### Exemplary Embodiments:

In a first embodiment, the one or more printed surface comprises a separate sheet of material that is connected to the pinwheel assembly at one or more attachment points. The attachment points may be on the blades of the pinwheel or may be at the central housing of the pinwheel assembly. The attachment may be by adhesive, wire, staple, or other fastener. The attachment of the printed sheet to the pinwheel enables the sign to spin when the wind rotates the pinwheel.

The printed sheet may comprise a central hole through which the axle of the pinwheel passes, and around which axle the printed sheet rotates. In an alternative embodiment, the printed sheet caps the end of the axle.

The printed sheet can be of any shape. Especially preferred shapes are concentric shapes, having a common center which facilitates smooth rotation. Exemplary concentric shapes are circles, hexagons, octagons, squares, equilateral triangles, etc. Eccentric shapes without a common center may be used as well. In most implementations, the printed sheet will be of the same diameter (if circular) or size/shape as the pinwheel assembly to which it is affixed. In some embodiments, the pinwheel assembly is smaller than the printed sheet and is not visible when the printed sheet is viewed head on.

The printed sheet of material may be composed of any material, including for example vinyl, plastic, paper, cardboard, or other printable materials known in the art. It will be understood that the printed sheet may comprise various stacked layers, for example, a printed layer (e.g. a thin layer of paper, vinyl, plastic) bearing graphics, and a backing layer comprising a stiff, durable material for support (e.g. plastic) so that the sheet holds its shape. A transparent, weatherproof coating may be layered on top of the printed layer to protect it from water and UV fading.

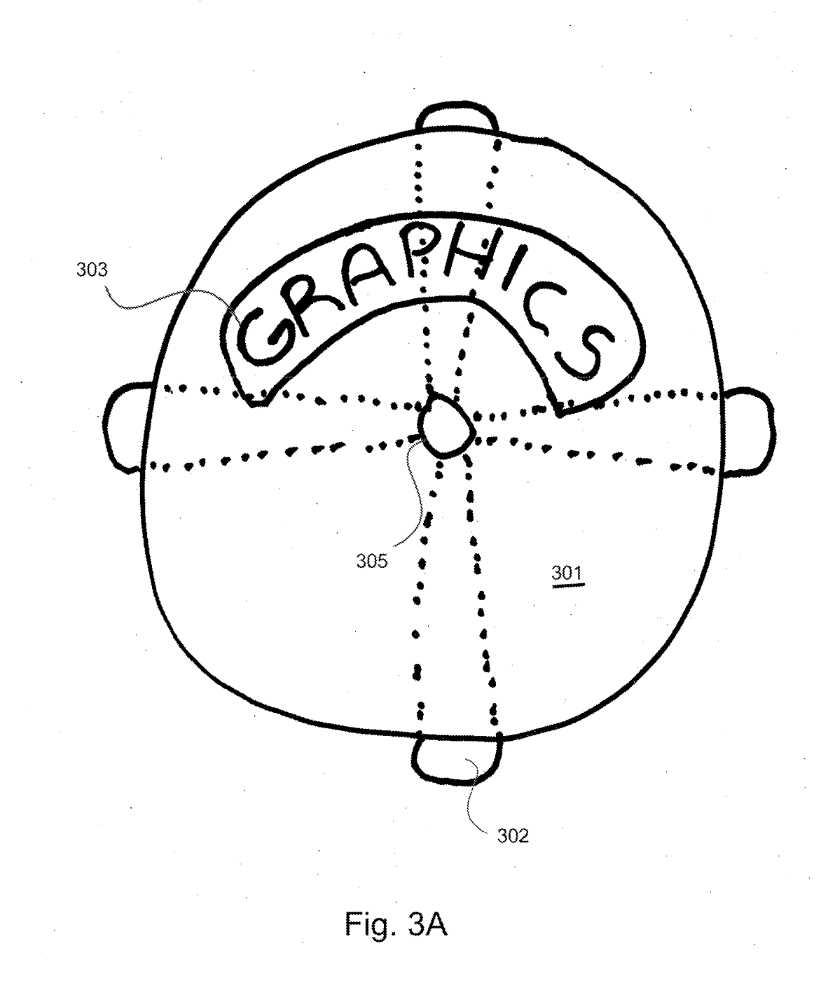

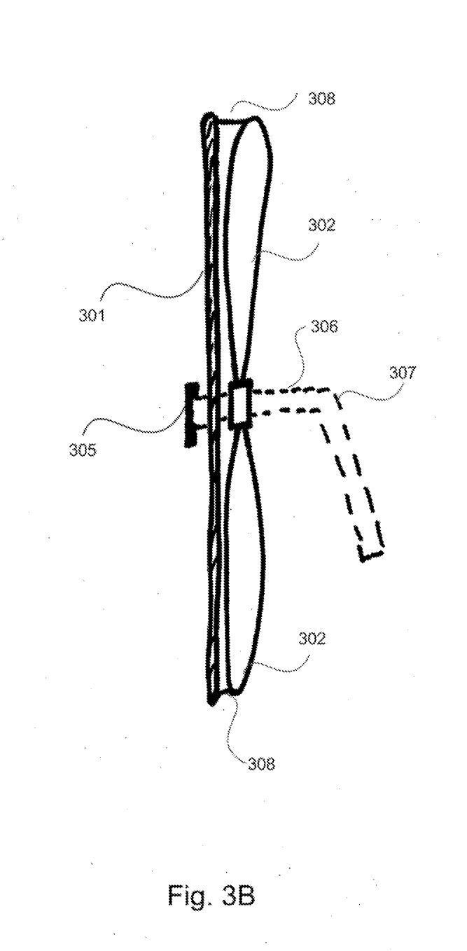

An exemplary pinwheel sign comprising a printed sheet is depicted in FIGS. 3A and 3B. The pinwheel sign depicted in FIG. 3A is shown head-on, facing the viewer. The printed sheet element (301) comprises a flat, circular piece of material, having one or more graphics (303) printed thereon. The central hole of the sheet is covered by a flange or cap (305). Behind the sign is a pinwheel comprising a plurality of blades (302). The integrated pinwheel and sheet is depicted in a side view in FIG. 3B. FIG. 3B shows the axle (306) which passed through the center of the pinwheel and sign. A flange or removable cap (305) keeps the sign from slipping off the end of the axle. Optionally, a second flange may be located behind the pinwheel to keep the unit from slipping back along the axle (not shown). The sheet of material is connected to the pinwheel at one or more attachment points (308). The axle may be in connection with an arm (307) that enables attachment to a pole or other structure.

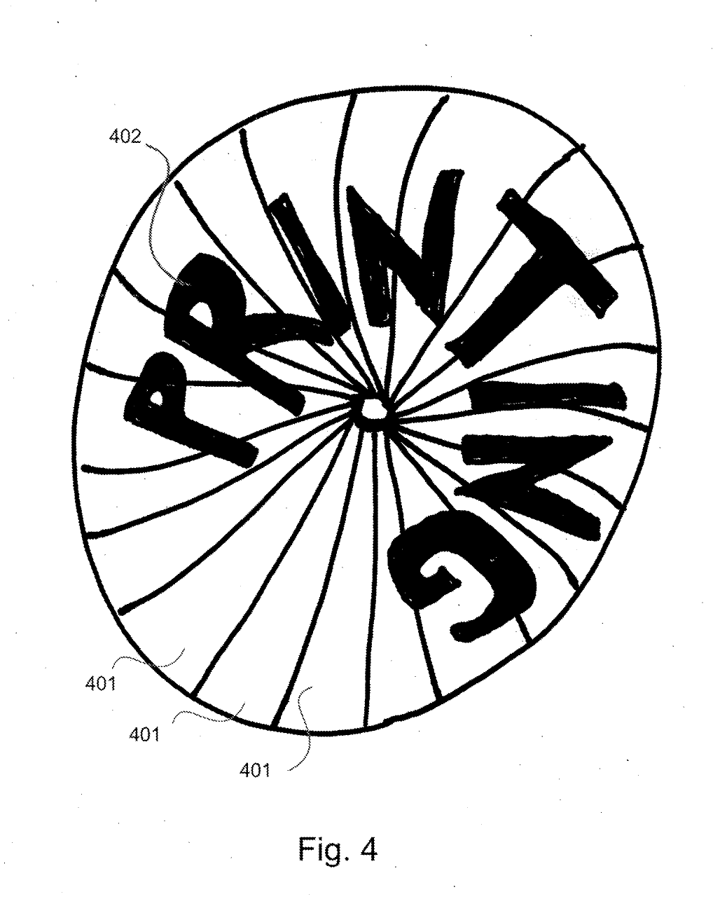

In a second embodiment, a “printed pinwheel configuration,” the printed surface does not comprise a separate printed sheet element and the blades of the pinwheel assembly comprise the printed surface. An exemplary printed pinwheel is depicted in FIG. 4. Here, the pinwheel assembly comprises a plurality of radially arranged blades (401). One or more of the blades are printed with graphics (402) such that the collection of blades, when viewed head-on, will make words, pictures, designs, or other graphics.

Size. The pinwheel signs of the invention may be of any size. Common sizes will be in the range of 1-6 feet in diameter or width. In one embodiment, the sign is a circle having a diameter of 12-36 inches.

Support structure. The axle of the pinwheel sign may be permanently or removably attached to a support structure by an arm. The arm comprises a substantially rod-like body. At one end, the arm will comprise the axle of the pinwheel sign and at the opposite end, the arm will comprise structures that enable it to be secured to the support structure. The support structure can be any structure which holds the arm. For example, in one embodiment, the support structure is a pole. The pole may be planted in the ground, or may have a weighted base, allowing it to stand upright while supporting one or more pinwheel signs. The support structure may be an A-frame body. In another embodiment, the support structure is a bracket, such as an L-bracket, which can be affixed to a wall or other surface to mount the sign (e.g by screws or nails). Alternatively, the inward end of the axle may comprise a clip or clamp which allows it to be mounted to a structure.

In some embodiments, the sign is removable from the support structure, so that the sign can be stored when not in use. Any structure or combination of structures which enables removal of the sign elements from the support.

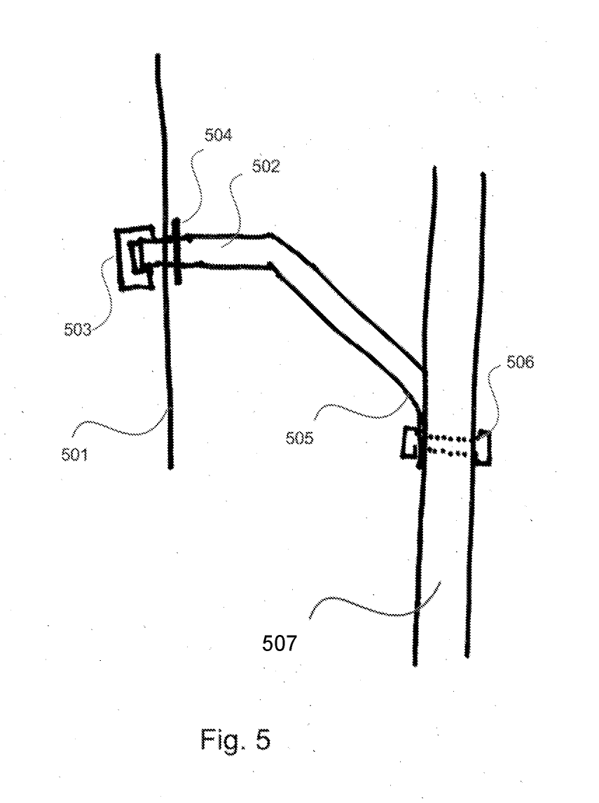

An exemplary attachment of the sign to a pole is depicted in FIG. 5. In FIG. 5, the pinwheel and sign element are depicted as a single unit (501), shown from the side. The pinwheel-sign element rotates around an axle (502). A flange (504) sits rearward of the pinwheel sign element to keep it from slipping backwards. The front of the axle comprises a cap (503), which may be removable. The axle is in connection with an arm (505) which connects the sign to the pole (507). The arm may be held to the pole by an attachment means (506), for example a cotter pin, screw, or other fastener having complementary elements on or in the pole, such as a hole through which a screw or pin passes.

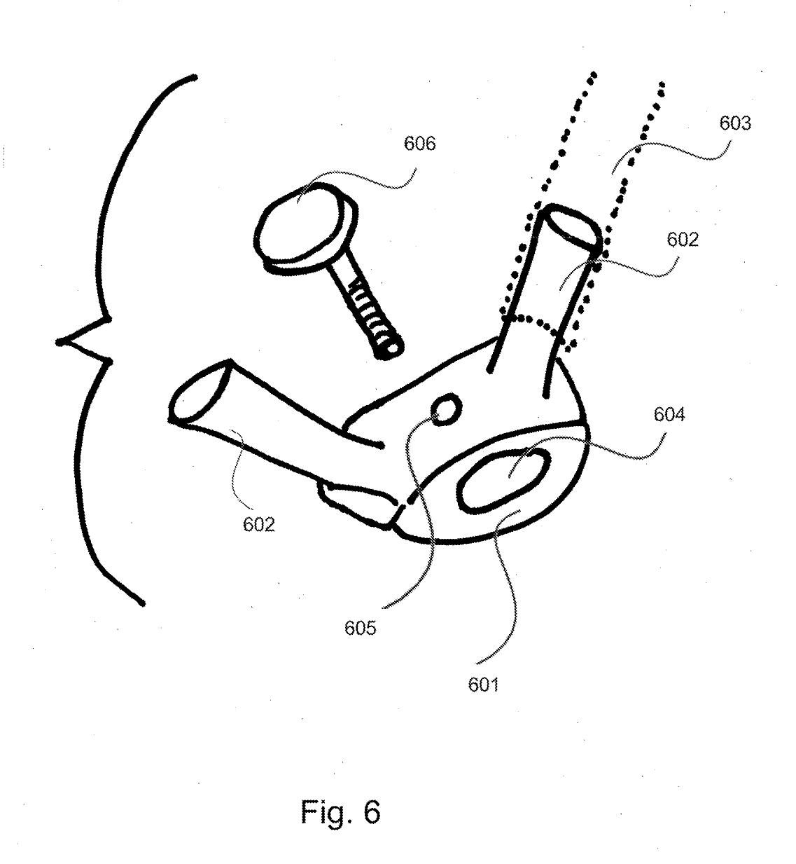

In another embodiment, the means for attaching the signs to the pole comprises a novel mounting device, depicted in perspective view in FIG. 6. The mounting device comprises a body (601) having a hole in its central portion (604). A pole (not shown) can be slid through the hole. The body further comprises one or more mounting structures (602) to which a pinwheel sign can be mounted. The body further comprises one or more holes (605) through which a pin, screw or other body (606) can be inserted to secure the body to the pole, and to conveniently rotate the body around the pole and position it at a desired height on the pole. In one embodiment, the mounting structures are protrusions such as tubular protrusions. These tubular protrusions can slide concentrically into the bottom end of tubular brackets or arms (603) to which a pinwheel sign is mounted, for example as depicted in FIG. 6. Alternatively, the bracket or arm may slide concentrically into the tubular mounting structure. Optionally, a locking mechanism such as a pin, pole spring lock, or other fastener can be used to secure the sign to the mounting structures. The mounting bodies may protrude from the body at an angle, for example a 45-135 degree angle. In an alternative embodiment, the mounting structures protrude at a right angle from the body and comprise (or are in connection with) the axle of the pinwheel sign.

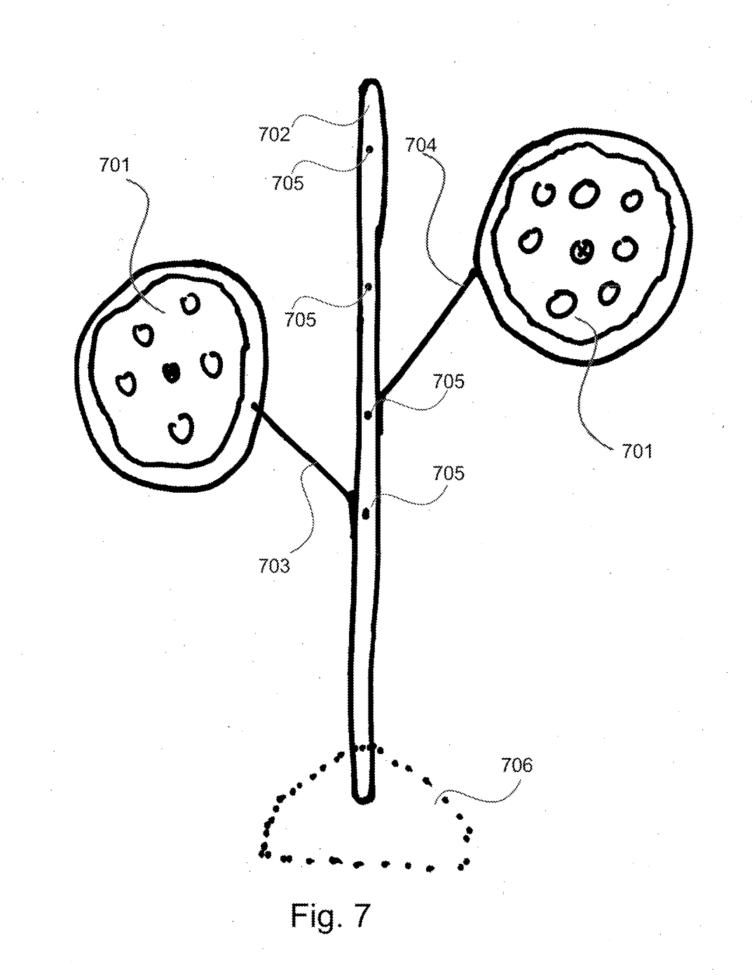

An exemplary signage apparatus is depicted in FIG. 7. The system of FIG. 7 comprises a pole (702). The pole has a plurality of hole through it at different positions (705) allowing for adjustment of the signage position. Two pinwheel signs (701), printed with pizza graphics, are affixed to the pole by arms (703 and 704). The pole may be planted in a base (706), or may be secured in a complementary hole or structure such as a flagpole bracket.

It will be noted that the diagrams provided herein are not to scale and are meant to depict the arrangement of the various elements making up the various embodiments of the invention. It will be understood that these diagrams are illustrative only and the elements may be differently sized, shaped, and arranged.

Motorized Rotation. In one embodiment, the pinwheel signs of the invention comprises a motor which rotates the axle or housing (When the sign is affixed to the axle or housing) or the sign (when the sign spins freely around the axle). The motor can optionally be turned on or off depending upon wind conditions. The motor can be connected to a power line, can be battery operated, or can be powered by a small solar panel.

Lighting. The pinwheel sign may optionally comprise lighting elements, such as LED's, el-wire, or other lighting elements that enhance visualization. The lighting elements can be connected to a power line, can be battery operated, or can be powered by a small solar panel.

Methods of Use. It will be understood that the scope of the invention encompasses methods of displaying graphics using the various devices described above.

### EXAMPLES

### Example 1

Sign for pizza or other round object. In one embodiment, the sign is a circular sign. The sign can be printed with graphics such that it resembles a round object. For example, the sign may comprise a circular sign resembling a pizza, as depicted in FIG. 7. Signs substantially similar to those depicted in FIG. 7 were constructed using circular sheets of printed vinyl affixed to a pinwheel essentially as depicted in FIG. 2. The signs were mounted to a pole and were able to rotate in very low winds, for example, winds of about 1-3 miles per hour.

1. A spinning sign, comprising
a pinwheel assembly comprising two or more blades arranged radially around a central housing having a hole, wherein the blades are configured to catch air currents;
an axle passing through the hole of the central housing, around which the blades may spin; and
one or more printed surfaces.

2. The spinning sign of claim 1, wherein
the one or more printed surfaces comprises a printed sheet of material which is in connection with the pinwheel assembly such that the printed sheet of material will spin when the pinwheel assembly rotates around the axle.

3. The spinning sign of claim 1, wherein
one or more blades of the pinwheel assembly comprise the one or more printed surfaces.

4. The spinning sign of claim 1, wherein
the sign is circular.

5. The spinning sign of claim 4,
wherein the outward facing surface of the printed sign is printed with graphics that depict a circular object.

6. The spinning sign of claim 5,
wherein the circular object is a pizza.

7. The spinning sign of claim 1,
further comprising a motor which rotates the sign.

8. A device comprising spinning signage, comprising
a pole;
one or more spinning pinwheel signs, each of the one or more spinning pinwheel signs comprising a plurality of blades, one or more printed surfaces, and an axle around which sign spins; and
one or more arms, wherein each of the one or more arms is in connection with the pole by a fastening means at one end and is in connection with the axle of a pinwheel sign at the other.

9. A device for mounting one or more pinwheel signs to a pole; comprising
a body, wherein the central portion of the body comprises a hole through which a pole may be placed;
one or more mounting structures, each of the one or more mounting structures comprising a structure to which one end of a pinwheel sign arm may be fastened;
a locking means, allowing the body to be secured to the pole.
